(19) United States
(12) Patent Application Publication
(10) Pub. No.: US 2008/0027784 A1
(43) Pub. Date: Jan. 31, 2008

(54) Goal-service modeling

(76) Inventors: Jenny Siew Hoon Ang, San Francisco, CA (US); Ali P. Arsanjani, Fairfield, IA (US); Lyubov Cherbakov, McLean, VA (US); George M. Galambos, Montreal (CA); Kerrie Lamont Holley, Montara, CA (US); David Hugh Janson, Raleigh, NC (US)

Correspondence Address: IBM CORPORATION, IPLAW SHCB/40-3, 1701 NORTH STREET, ENDICOTT, NY, 13760, US

(21) Appl. No.: 11/496,917

(22) Filed: Jul. 31, 2006

(51) Int. Cl. G06F 17/30

(52) U.S. Cl. 705/10

(57) ABSTRACT

Software services for a business are identified. The goals for the business to meet its objectives are identified. Sub-goals are then identified recursively until services can be identified for fulfilling each of the sub-goals. Performance indicators are identified for each of the sub-goals. Each indicator has a metric identifying the type of measurements that need to be collected to assess the state of the corresponding indicator. Services and indicators are entered in a services portfolio database. A services solution for the business is then implemented using a services oriented architecture using the services in the portfolio.

### TECHNICAL FIELD

The invention relates to methods of engaging a client company for the purpose of business transformation. More particularly, the invention relates to methods for moving from prior art business models created through component business modeling or other techniques to new models required by a service-oriented architecture solution design.

### BACKGROUND OF THE INVENTION

Object-oriented applications are built on the structuring elements of classes and objects. More recent business modeling techniques group objects into components and expose interfaces. Components, therefore, have become the primary structuring unit of business software applications. Components represent a run-time deployable unit of functionality.

For example, Rackham in US Patent application US2005/0203784 describes a method of providing business process services to a client company through components of activities. The components are groups of cohesive business activities supported by appropriate processes, applications, infrastructure, and metrics. Veryard describes component modeling in his book, The Component Based Business, published by Springer-Verlog, London 2001. Underwood in U.S. Pat. No. 6,601,233 describes a framework for business components. The documents listed above by Rackham, Veryard, and Underwood are hereby incorporated by reference in their entireties for any purpose.

The use of service-oriented architecture (SOA) techniques decouples interfaces from implementation through use of its service provider and service consumer structure. With SOA, services are the primary structuring element for business applications. Service-oriented architecture implementations are described in the papers “Service-Oriented Architecture: Programming Model and Product Architecture,” by Ferguson and Stockton, IBM Systems Journal, Volume 44, No. 4, October 2005, pp. 753-780, and “Impact of Service Orientation at the Business Level,” by Cherbakov et al., IBM Systems Journal, Volume 44, No. 4, December 2005, pp. 653-668. These two papers are hereby incorporated by reference.

Service-oriented modeling is necessary to build a service-oriented architecture. Service-oriented modeling includes identification, specification, and realization of services, components, and flows. It requires modeling the attributes of each service and their relationships. It is a method for the analysis and design of services.

Service-oriented modeling methods 14, therefore, take their inputs from component based modeling approaches 12 and deliver their outputs to a service-oriented architecture implementation 16 as shown in FIG. 1. While various technologies have been used for service-oriented modeling in the recent past, there exists a desire for improvement and enhancements to these techniques. It is believed that such improvements would constitute a significant contribution to the business modeling arts.

### OBJECTS AND SUMMARY OF THE INVENTION

It is therefore a principal object of the present invention to provide an improved service-oriented modeling method.

It is another object to provide such a method wherein enhanced service-oriented architecture implementations are possible.

It is yet another object of the invention to provide a method for service-oriented modeling which can be accomplished in a facile manner.

These and other objects are attained in accordance with one embodiment of the invention wherein there is provided a method of determining services for a business, comprising the steps of, identifying goals and sub-goals for a business, identifying services for fulfilling each of the sub-goals; and identifying performance indicators for each of the sub-goals, each of the indicators having a metric for the corresponding service.

### BRIEF DESCRIPTION OF THE DRAWINGS

FIG. 1 is a high-level flowchart of a client engagement process;

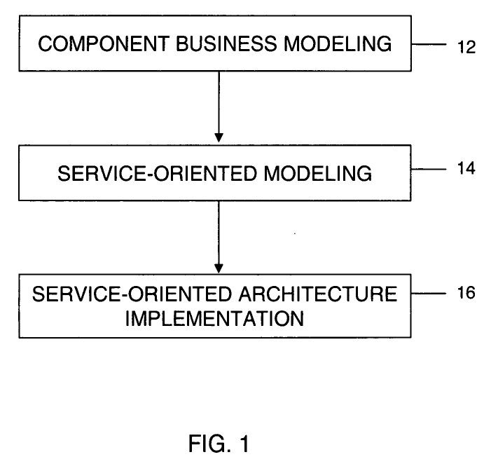

FIG. 2 is a diagram of a service-oriented models,

FIG. 3 shows approaches for filling a service portfolio; and

FIG. 4 is a flowchart listing steps of a goal service modeling method.

### BEST MODE FOR CARRYING OUT THE INVENTION

For a better understanding of the present invention, together with other and further objects, advantages and capabilities thereof, reference is made to the following disclosure and the appended claims in connection with the above-described drawings.

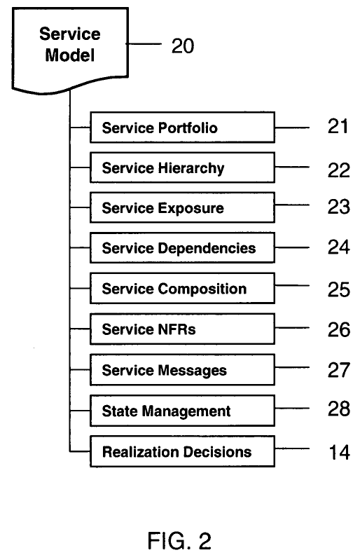

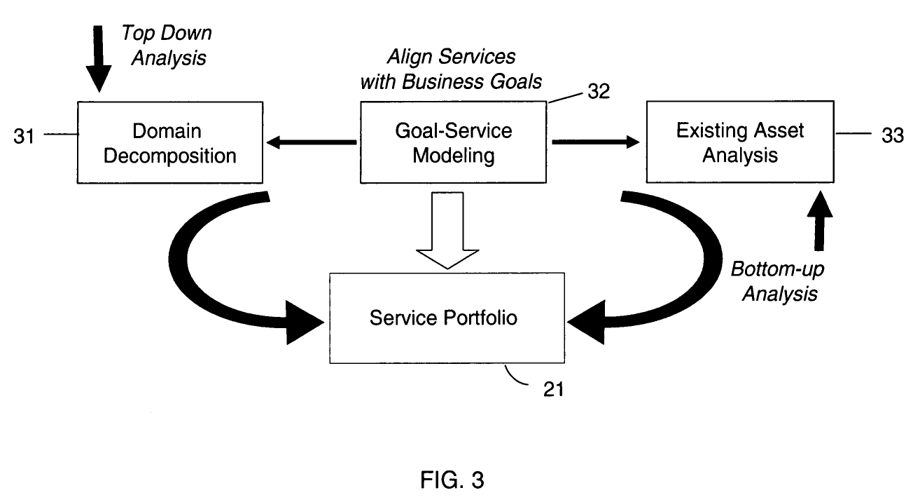

In FIG. 2, there is shown the elements 21-29 of service-oriented model 20. Service portfolio 21 has candidate services discovered during service-oriented modeling identification activities. These activities involve three complementary approaches as shown in FIG. 3. Domain decomposition 31 is a top-down business-driven view which analyzes key business aspects to identify services. Goal-service modeling 32 establishes alignment between services and business goals, and is the principal subject matter of the present invention. Existing asset analysis 33 identifies functionality that can be exposed as services using multiple asset sources such as existing systems and industry models.

As used herein, a service is taken to mean a software resource with an externalized service specification. This service specification is available for searching, binding, and invocation by a service consumer. A service provider realizes the service specification implementation and also delivers the quality of service required by the service consumer. Services are governed by declarative policies and thus support a dynamically re-configurable architectural style.

A domain shall be taken to denote a large business area consisting of a logical grouping of business capabilities that provide related business functions and require similar skills and expertise, such as financial services management, product development, or business administration. A domain corresponds to a component business modeling (CBM) competency.

Services hierarchy 22 consists of candidate services organized using a business significant categorization scheme. This makes evaluation of the candidate service more manageable, and helps avoid unnecessary service proliferation. The categorization may be as simple as an outline or as involved as semantic web taxonomy or ontology. The service exposure element 23 lists decisions of why a given candidate service in service hierarchy 22 was exposed. Service dependencies 24 lists dependencies between services in model 20. Service composition 25, if needed, is a choreography of service to form a composite service. Service NFRs 26 are non-functional requirements of the services. Service messages 27 are messages that are exchanged between a service consumer and a service provider. State management 28 are architectural decisions relating to state management. Realization decisions 29 are architectural decisions dealing with how the services will be realized, such as buy, build, or subscribe.

Goal-service modeling 32 identifies services for portfolio 21 by linking business goals with services that will fulfill these. Business organizations define goals to meet their mission and to set strategic direction. The terms goals, business goals, and strategic goals are often used to mean business aspirations. As used herein, the term goal shall denote a business aspiration, such as increase revenue by five percent.

Once a business has analyzed its mission and defined its goals, it needs a way to measure progress toward those goals. Key performance indicators (KPIs), also known as key success indicators or key business indicators are used by businesses to define and measure progress toward their goals. As used herein, KPIs represent quantifiable, measurable objectives, agreed to beforehand, that reflect the critical success factors of an organization.

KPIs differ depending on an industry or organization. A sales organization may use the percentage of its sales that come from return customers. A customer service organization may measure the number of customer service calls answered in less than one minute. To determine if the objectives associated with a KPI are being met, the KPI may need to be broken down into one or more metrics, which are specific measurements to collect for analysis, such as time to close an average sales deal.

While the primary objective of the goal-service modeling method is to align services with business goals and identify services, the method is also used to filter out those services that do not meet business goals. The identified services are added to service portfolio 21 along with services those services identified using the domain decomposition 31 and existing asset analysis 33 processes. Services added to portfolio 21 at this identification stage are service candidates, not a final decision on service exposure.

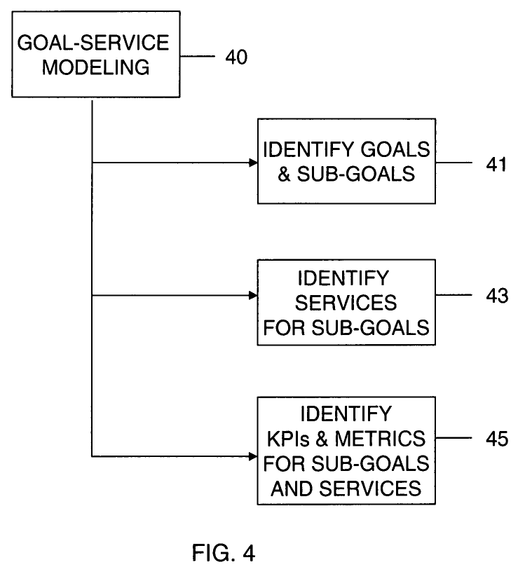

Using the goal-service modeling method 40 shown in FIG. 4 ensures that identified services are business aligned. In step 41, goals important to the business are identified. These goals are broken down into a set of sub-goals in a recursive fashion. Typically, three to four levels of sub-goals will suffice. However, the breaking down stops once the identified sub-goals reach a point at which services needed to fulfill the sub-goals can be identified in step 43.

Goals give an indication of what really matters to a business at a specific point in time and what will be a priority in the future. Therefore, goals are identified that are important within a context of an initial scoping effort for a project. For example, component business modeling or other business modeling and analysis methods may provide a means to define the scope and focus of a project. The focus area will be the context in which business goals are analyzed. High level goals tend to be vague, such as quality and revenue. These are broken down to more detailed sub-goals that are pre-requisites to the achievement of high level goals. The goals and sub-goals may be identified through interviews with executives and financial analysts in the business.

If new services are identified in step 43, they are added to service portfolio 21 of service model 20. In step 45, for each of the sub-goals, KPIs are identified that will be used to determine metrics that can be measured for the attainment of the sub-goals through the identified services. The KPIs will provide the business with a measure of success in meeting its goals and sub-goals. For example, for a goal of increase revenue, a KPI could be to increase revenue by five percent during the next fiscal year. This provides a specific way to determine if the goal has been met.

Metrics identify the type of measurements that need to be collected to assess the state of the KPIS. For the example KPI above, a metric could be to record the revenue from all revenue generating transactions.

The identified services and indicators may be entered into a database running on an information handling system (IHS), such as an ordinary workstation computer, laptop, server, or the like. Software code may also be running on the IHS for assisting the identifying and entry of goals and sub-goals. Code may also assist in identifying and entry of services, indicators, and metrics into the database. The code may be created and executed in any known programming language.

While there have been shown and described what are at present considered the preferred embodiments of the invention, it will be obvious to those skilled in the art that various changes and modifications may be made therein without departing from the scope of the invention as defined by the appended claims.

What is claimed is:

1. A method of determining services for a business, comprising the steps of:
identifying goals and sub-goals for a business;
identifying services for fulfilling each of said sub-goals; and
identifying performance indicators for each of said sub-goals, each of said indicators having a metric for the corresponding service.

2. The method of claim 1, wherein said goals and sub-goals are identified for said business to meet its mission and set strategic direction.

3. The method of claim 1, wherein said sub-goals are identified in a recursive manner until services can be identified for fulfilling said sub-goals.

4. The method of claim 1, wherein said services have an externalized service specification.

5. The method of claim 1, wherein said services are governed by declarative policies supporting a dynamically re-configurable architectural style.

6. The method of claim 1, wherein said metric identifies the type of measurements that need to be collected to assess the state of the corresponding indicator.

7. The method of claim 1, further comprising the step of entering said services and said indicators in a service portfolio database.

8. A method of deploying a services solution to a business, comprising the steps of:
identifying goals and sub-goals for a business;
identifying services for fulfilling each of said sub-goals;
identifying performance indicators for each of said sub-goals, each of said indicators having a metric for the corresponding service;
entering said services and said indicators in a service portfolio database;
selecting a set of said services for said solution for said business; and
implementing said set of said services as a service oriented architecture.

9. A system for determining services for a business, comprising:
a services portfolio database on an information handling system;
means for identifying goals and sub-goals for said business;
means for identifying services for fulfilling each of said sub-goals;
means for identifying performance indicators for each of said sub-goals, each of said indicators having a metric for the corresponding service; and
means for entering said services and said indicators into said database.
